(19) United States
(12) Patent Application Publication
(10) Pub. No.: US 2026/0106769 A1
(43) Pub. Date: Apr. 16, 2026

(54) DATA PACKET CHARACTERIZATION WITH COMMUNICATION USAGE INFORMATION

(71) Applicant: T-MOBILE INNOVATIONS LLC, Overland Park, KS (US)

(72) Inventors: Narayanan Govindan Kasi, Olathe, KS (US); Saravana Velusamy, Overland Park, KS (US)

(21) Appl. No.: 18/912,184

(22) Filed: Oct. 10, 2024

(51) Int. Cl. H04L 12/14; H04L 41/06; H04L 47/32

(52) U.S. Cl. CPC H04L 12/1407; H04L 12/1435; H04L 47/32; H04L 41/06

(57) ABSTRACT

A data communication system receives data packets for a user. The data communication system applies a rule for the user to the data packets. The data communication system drops the data packets in response to applying the rule. The data communication system generates a record for the user that associates the rule with the dropped data packets. The data communication system may also drop data packets in response to a system failure. The data communication system generates a record for the user that associates the system failure with the dropped data packets.

### TECHNICAL BACKGROUND

Wireless communication networks provide wireless data services to wireless communication devices like phones, computers, and other user devices. The wireless data services may include internet-access, user messaging, voice/video calling, or some other data communication product. The wireless communication networks comprise wireless access nodes like Wireless Fidelity (WIFI) hotspots, Fifth Generation New Radio (5GNR) cell towers, and satellites in earth orbit. The wireless communication networks further comprise network elements the process network signaling and handle user data like User Plane Functions (UPFs), Session Management Functions (SMFs), and Charging Functions (CHFs).

To generate a user bill, the network elements generate usage information for the user like the amount of transferred data, data rate, date, time, endpoints, and the like. The network elements transfer the usage information to a billing system. The billing system generates the user bill based on the usage information. For example, a UPF may transfer usage information to an SMF that augments the usage information with subscriber and control information to generate usage events. The SMF transfers the usage events to a CHF that generates Charging Data Records (CDRs) based on the events. The CHF transfers the CDRs to the billing system.

A wireless communication network will drop user data packets for various reasons. In some cases, a network failure or network congestion causes the packet drop. In other cases, the user may exceed a spending limit or some other usage threshold that causes the packet drop. Network personnel aggregate and sift through this information to correct the user bill or explain the network service delivery to the user. The usage data and CDRs do not effectively and efficiently support network personnel with these customer service tasks.

### TECHNICAL OVERVIEW

In some examples, a method comprises the following operations. Receive data packets for a user and apply a rule for the user to the data packets. Drop the data packets in response to applying the rule. Generate a record for the user that associates the rule with the dropped data packets.

In some examples, a method comprises the following operations. A user-plane network element receives data packets for a user. A control system applies a Policy and Charging Control (PCC) rule for the user. The user-plane network element drops the data packets for the user in response to the control system applying the PCC rule for the user. The user-plane network element generates usage information for the dropped packets. A Charging Trigger Function (CTF) generates event information for the user based on the usage information. A Charging Data Function (CDF) generates a Charging Data Record (CDR) for the user that associates the dropping of the user data packets with the PCC rule.

In some examples, a data communication system comprises a data system and a control system. The data system receives data packets for a user. The control system applies a rule for the user to the data packets. The data system drops the data packets in response to the control system applying the rule. The control system generates a record for the user that associates the rule with the dropped data packets.

### DESCRIPTION OF THE DRAWINGS

FIG. 1 illustrates an exemplary data communication system to generate usage information that characterizes data packet communications.

FIG. 2 illustrates an exemplary operation of the data communication system to generate the usage information that characterizes the data packet communications.

FIG. 3 illustrates an exemplary operation of the data communication system to generate the usage information that characterizes the data packet communications.

FIG. 4 illustrates exemplary processing circuitry to generate usage information that characterizes data packet communications.

FIG. 5 illustrates an exemplary wireless communication network to generate Charging Data Records (CDRs) for packet communications that indicate rules and network failures that cause packet drops.

FIG. 6 illustrates an exemplary wireless UE in the wireless communication network that generates CDRs for packet communications that indicate rules and network failures that cause packet drops.

FIG. 7 illustrates an exemplary Fifth Generation New Radio (5GNR) Access Node (AN) in the wireless communication network that generates CDRs for packet communications that indicate rules and network failures that cause packet drops.

FIG. 8 illustrates an exemplary Wireless Fidelity (WIFI) AN in the wireless communication network that generates CDRs for packet communications that indicate rules and network failures that cause packet drops.

FIG. 9 illustrates an exemplary Satellite (SAT) AN node and SAT Ground Station (GND) in the wireless communication network that generates CDRs for packet communications that indicate rules and network failures that cause packet drops.

FIG. 10 illustrates an exemplary Network Function Virtualization Infrastructure (NFVI) in the wireless communication network that generates CDRs for packet communications that indicate rules and network failures that cause packet drops.

FIGS. 11-12 illustrate an exemplary operation of the wireless communication network to generate CDRs for packet communications that indicate the rules and charging actions that cause packet drops.

FIGS. 13-14 illustrate an exemplary operation of the wireless communication network to generate CDRs for packet communications that indicate the network failures that cause packet drops and their associated alarms.

### DETAILED DESCRIPTION

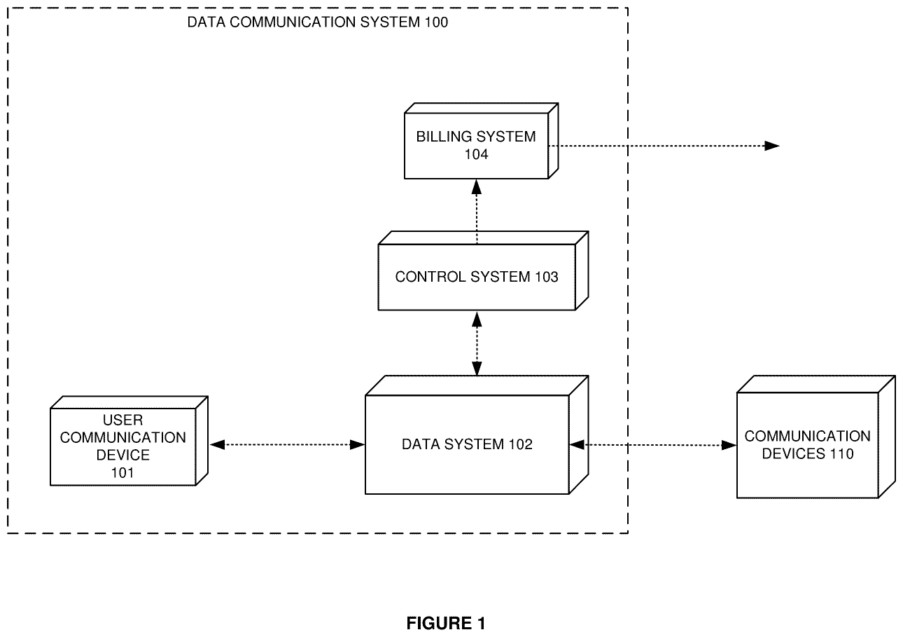

FIG. 1 illustrates exemplary data communication system 100 to generate usage information that characterizes data packet communications. Data communication system 100 comprises user communication device 101, data system 102, and control system 103, and billing system 104. User communication device 101 comprises a phone, computer, and/or some other user apparatus with data communication components. Data system 102 comprises Access Nodes (ANs), User Plane Functions (UPFs), and/or some other user-plane apparatus. Control system 103 comprises Session Management Functions (SMFs), Charging Functions (CHFs), and/or some other control-plane apparatus. Billing system 104 comprises an accounting server, Artificial Intelligence (AI) computer, and/or some other components that generate user bills. Communication devices 110 are external to data communication system 100 in this example, but communication devices 110 could be a part of data communication system 100 in other examples.

In some examples, data system 102 receives data packets for a user from user communication device 101 and/or communication devices 110. Control system 103 applies a rule for the user to the data packets. Data system 102 drops the data packets in response to control system 103 applying the rule. For example, a rule may cause data system 102 to drop data packets for a user to limit user spending. In another example, a rule may cause data system 102 to drop data packets to mitigate system congestion. Data system 102 drops the data packets by not transferring them to their intended destination, and system 102 may delete or store the dropped data packets. Control system 103 generates a record for the user that associates the rule with the data packets that are dropped based on the rule. Data system 102 may perform a charging action to drop the data packets, and the record for the user associates the charging action with the dropped data packets. In other examples, data system 102 drops the data packets in response to a system failure. Control system 103 generates a record for the user that associates the system failure with the dropped data packets. The system failure may cause an alarm, and the record for the user associates the alarm with the dropped data packets.

The rule may comprise a Policy and Charging Control (PCC) rule. Control system 103 may comprise a Policy Control Function (PCF) that transfers the PCC rule for the user to a Charging Trigger Function (CTF). The CTF generates usage reporting instructions for the user based on the PCC rule. The CTF transfers the usage reporting instructions for the user to a user-plane network element in data system 102. The user-plane network element that generates usage information for the user based on usage reporting instructions. The CTF generates event information for the user based on the usage information. Control system 103 comprises a Charging Data Function (CDF) that generates a Charging Data Record (CDRs) for the user based on the event information. The CDRs associate packets drops with their rules, charging actions, system failures, and alarms.

In some examples, data system 102 comprises a UPF that generates usage information for the user based on the rules for the user. Control system 103 comprises an SMF that generates event information for the user based on usage information. Control system 103 comprises a CHF that generates CDRs for the user based on the event information.

In some examples, control system 103 transfers the usage record to an Artificial Intelligence (AI) system. The AI system determines a user credit for the dropped data packets based on the record. The AI system may identify a technical deficiency with data communication system 100 in response to the record.

User communication device 101 and data system 102 may wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), satellite data communications, and/or some other wireless protocol. User communication device 101, data system 102, control system 103, and billing system 104 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

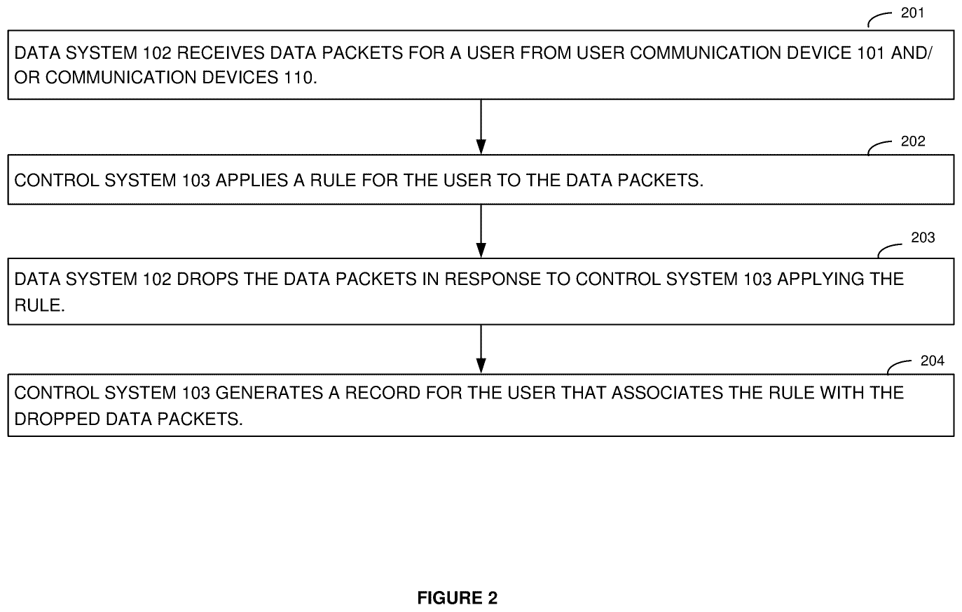

FIG. 2 illustrates an exemplary operation of data communication system 100 to generate the usage information that characterizes the data packet communications. The operation may differ in other examples. Data system 102 receives data packets for a user from user communication device 101 and/or communication devices 110 (201). Control system 103 applies a rule for the user to the data packets (202). Data system 102 drops the data packets in response to control system 103 applying the rule (203). Control system 103 generates a record for the user that associates the rule with the dropped data packets (204).

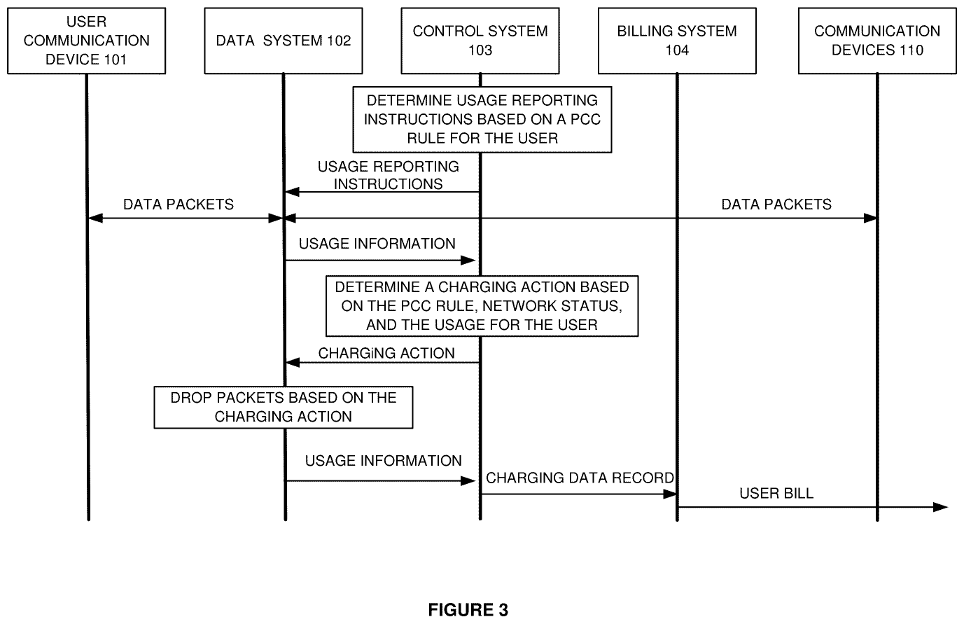

FIG. 3 illustrates an exemplary operation of data communication system 100 to generate the usage information that characterizes the data packet communications. The operation may differ in other examples. Control system 103 determines usage reporting instructions for user communication device 101 and data system 102 based on a PCC rule for the user. The usage reporting instructions direct data system 102 to report packet drops with their associated PCC rules, charging actions, system failures, and/or alarms. Control system 103 transfers the usage reporting instructions for user communication device 101 to data system 102. Data system 102 exchanges data packets between user communication device 101 and communication devices 110. Data system 102 generates usage information for user communication device 101 that characterizes the packet exchange like packet amount, data rate, date/time, endpoints, and the like. Data system 102 transfers the usage information for user communication device 101 to control system 103. Control system 103 determines a charging action based on the PCC rule, network status, and the usage information for user communication device 101. For example, the PCC rule may have a user spending limit, and the usage information may indicate that the spending limit has been reached, so the charging action is to drop data packets for the user until additional spending is authorized. In another example, the PCC rule may reduce the data rate for user communication device 101 during system overloads, so the charging action may be to drop data packets due to an overload. Control system 103 transfers the charging action to data system 102.

On turn, data system 102 may drop data packets to perform the charging action. Data system 102 generates usage information for user communication device 101 that associates the dropped packets with the PCC rule and the charging action. Data system 102 transfers the usage information that to control system 103. Control system 103 generates an Charging Data Record (CDR) based on the usage information, and the CDR associates the dropped packets with the PCC rule and the charging action. Control system 103 transfers the CDR to billing system 104. Billing system generates a user bill based on the CDR. Subsequently, network personnel or a system computer may process the CDR to modify the user bill, explain the delivered service to the user, and/or detect technical deficiencies.

The CDR indicates whether data packets for the user were dropped and why. System operations may use the CDR to troubleshoot issues like poor user service or network deficiencies. When data packets are dropped due to network congestion, a system failure, or some system-based reason, then the user may have their bill reduced. When packets are dropped to keep the user under their spending cap, a geographic restriction in their service plan, or some other user-based reason, then the bill is typically not reduced. System operations may also use the CDR to detect system deficiencies like a flawed PCC rule that inadvertently causes packet drops. For example, a PCC rule with an incorrect rating group may cause a packet flow to be dropped.

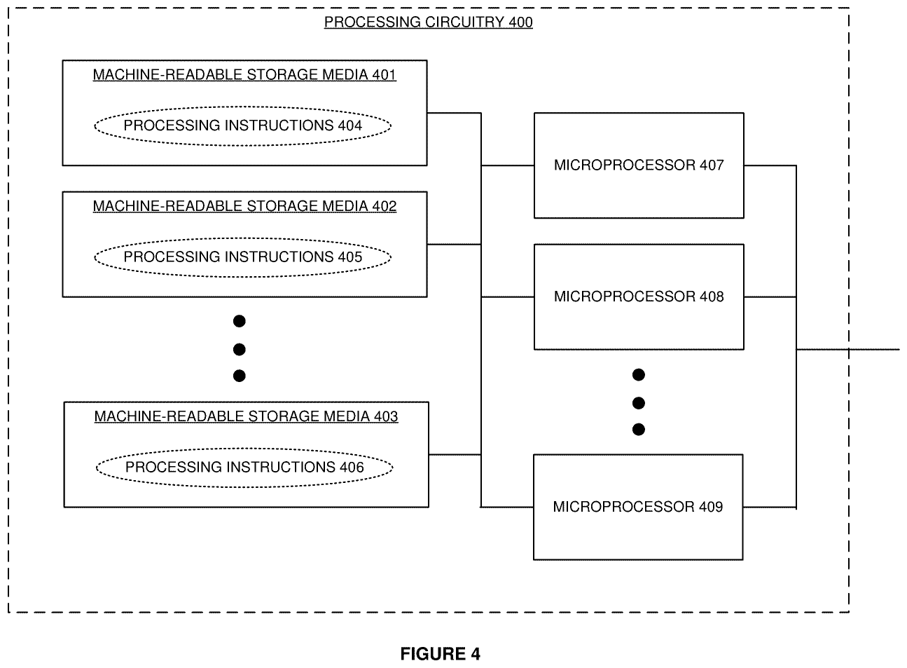

FIG. 4 illustrates exemplary processing circuitry 400 to generate usage information that characterizes data packet communications. Processing circuitry 400 comprises an example of user communication device 101, data system 102, control system 103, and billing system 104, although device 101 and systems 102-104 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to associate packet drops with rules and other data as described above for data communication system 100 and as described below for wireless communication network 500. The amount of storage media, microprocessors, processing instructions that are shown in FIG. 4 may vary in other examples.

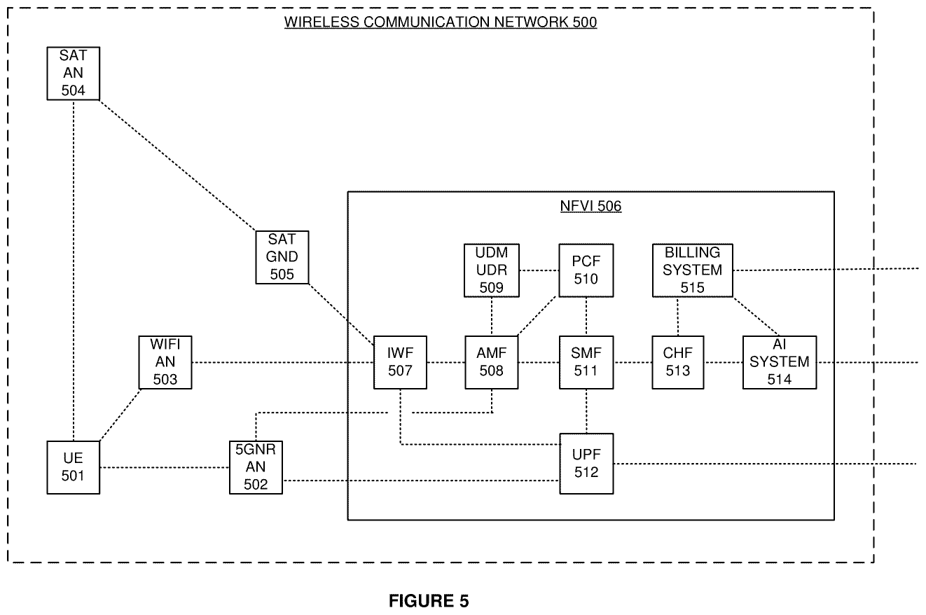

FIG. 5 illustrates exemplary wireless communication network 500 to generate Charging Data Records (CDRs) for packet communications that indicate rules and network failures that cause packet drops. Wireless communication network 500 comprises an example of data communication system 100 and processing circuitry 400, although system 100 and circuitry 400 may differ. Wireless communication network 500 comprises User Equipment (UE) 501, Fifth Generation New Radio (5GNR) Access Node (AN) 502, Wireless Fidelity (WIFI) AN 503, earth satellite (SAT) AN 504, satellite ground station (SAT GND) 505, and Network Function Virtualization Infrastructure (NFVI) 506. NFVI 506 comprises Interworking Function (IWF) 507, Access and Mobility Management Function (AMF) 508, Unified Data Management/Unified Data Repository (UDM/UDR) 509, Policy Control Function (PCF) 510, Session Management Function (SMF) 511, User Plane Function (UPF) 512, Charging Function (CHF) 513, Artificial Intelligence (AI) system 514, and billing system 515.

In operation, UE 501 registers with AMF 508 over 5GNR AN 502. AMF 508 retrieves subscriber information from UDM/UDR 509 that indicates network services for UE 501 like internet-access, data messaging, and voice calling. AMF 508 requests policies for UE 501 from PCF 510. PCF 510 retrieves the policies and PCC rules for UE 501 from UDM/UDR 509. SMF 511 retrieves the PCC rules for UE 501 from PCF 510. AMF 508 and SMF 510 interact to develop UE context for UE 501 based on the subscriber information and the policies. The UE context indicates internet addresses, quality-of-service, and the like for the network services delivered to UE 501. AMF 508 transfers the UE context to 5GNR AN 502 and UE 501. SMF 508 transfers the UE context to UPF 512. SMF 508 derives usage reporting instructions based on the PCC rules and transfers the usage reporting instructions to UPF 512. The usage reporting instructions require that packet drops be characterized by their amount, time, duration, and bandwidth loss. To the extant UPF 512 is able, the usage reporting instructions further require that packet drops be associated with the pertinent PCC rule, charging action, network failure, alarm, and/or other information.

In response to the context, UE 501 exchanges data packets with other systems (not shown) over 5GNR AN 502 and UPF 512. UPF 512 generates usage information for UE 501 based on the usage reporting instructions. The usage information indicates the data packet flows for the network services along with their data rate, start/stop times, packet drops, and other information. For a packet drop, the usage information indicates the amount of dropped packets, the duration/time of the packet drop, and the bandwidth loss due to the packet drop. The usage information may indicate the PCC rule, charging action, network failure, and/or alarm for the packet drop. UPF 512 transfers the usage information for UE 501 to SMF 511.

SMF 511 generates usage events for UE 501 based on the usage information. The usage events indicates the data packets flows along with their data rate, start/stop times, packet drops, and other information. For a packet drop, the usage events indicate the amount of dropped packets, the duration/time of the packet drop, and the bandwidth loss due to the packet drop. The usage events from SMF 511 also indicate the PCC rule, charging action, network failure, and/or alarm for the packet drop. SMF 511 transfers the usage events for UE 501 to CHF 513.

CHF 513 generates CDRs for UE 501 based on the usage events. The CDRs indicate the data packet flows along with their data rates, start/stop times, packet drops, and other information. For a packet drop, the CDRs indicate the amount of dropped packets, the duration/time of the packet drop, and the bandwidth loss due to the packet drop. The CDRs associate the packet drop with its pertinent PCC rule, charging action, network failure, alarm, and/or other information. The usage information, usage events, and CDRs may indicate other information related to a packet drop like slice, UE application, UE location, UE type, Uniform Resource Identifier (URI), Internet Protocol (IP) address, IP port, and the like. CHF 513 transfers the CDRs to AI system 514.

AI system 514 prompts its AI model with the CDRs. AI system 514 adds user credits to the CDRs for packet drops that are network-based like drops due to network congestion and network faults. AI system 514 annotates the CDR to explain the packet drops that are user-based like drops due to excessive spending and geographic restrictions. The AI model in AI system 514 also detects network deficiencies like flawed PCC rules, UPF defects, and the like. AI system 514 returns the CDRs to CHF 513 which transfers the CDRs to billing system 514. Billing system 515 generates a user bill for the network services that implements the user credits and annotations from AI system 514. AI system 514 may interact with the user and/or network personnel to describe the delivered services, packet drops, and network deficiencies.

Alternatively, UE 501 and UPF 512 may exchange data packets over WIFI AN 503 and IWF 507 or over SAT AN 504, SAT GND 505, and IWF 507. Other user-plane network elements like 5GNR AN 502, IWF 507, SAT AN 504, and SAT GND 515 may operate in a similar manner to UPF 512 to drop data packets and report the usage information for the packet drops. For example, SAT GND 505 may drop data packets due to a user spending limit and report the drop and its reason to SMF 511 over IWF 507 and AMF 508. IWF 507 may drop data packets due to an internal application failure and report the drop and its reason to SMF 511 over AMF 508.

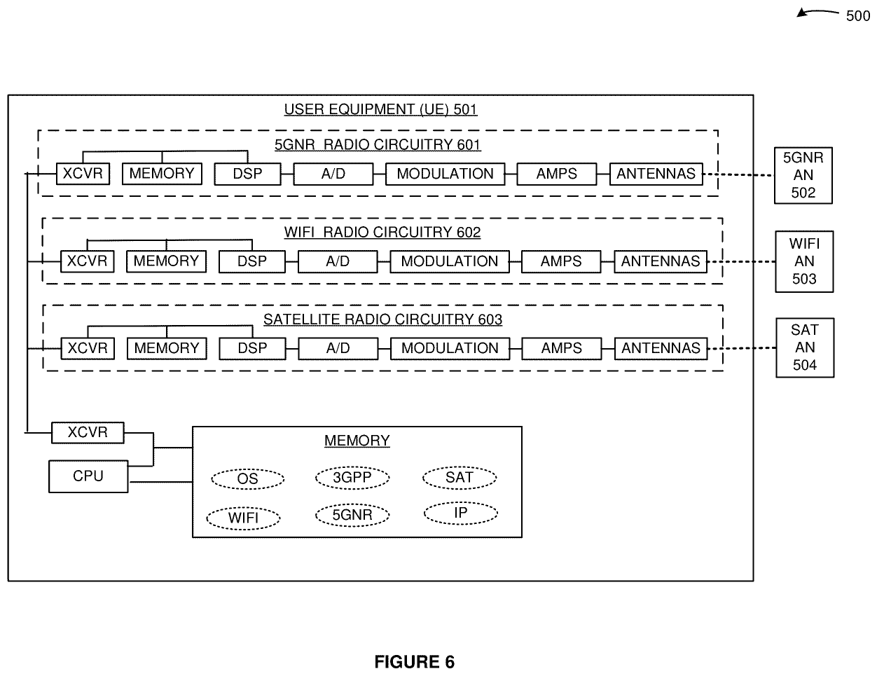

FIG. 6 illustrates exemplary wireless UE 501 in wireless communication network 500 that generates the CDRs for the packet communications that indicate the rules and the network failures that cause the packet drops. UE 501 comprises an example of wireless communication device 101 and processing circuitry 400, although device 101 and circuitry 400 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), and Internet Protocol Application (IP). The antennas in radio circuitry 601-603 exchange wireless signals with ANs 502-504. Transceivers in radio circuitry 601-603 are coupled to transceivers in processing circuitry 604. In processing circuitry 604, the one or more CPUs retrieve the software from the one or more memories and execute the software to direct the operation of UE 501 as described herein. In some examples, UE 501 drops data packets based on charging actions and/or network failures and reports the packet drops along with their associated charging actions and network alarms to SMF 511.

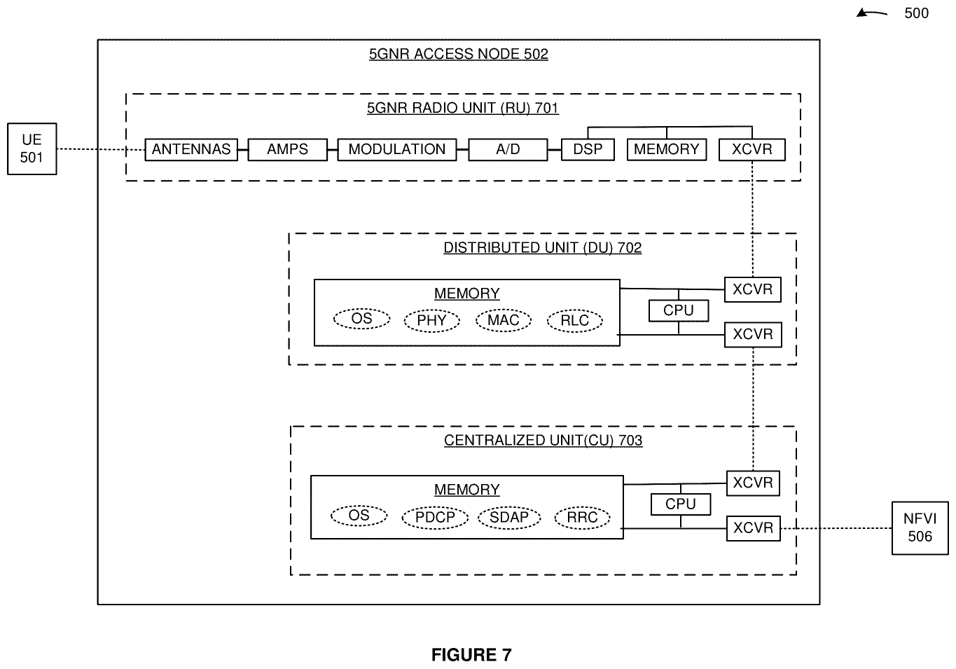

FIG. 7 illustrates exemplary Fifth Generation New Radio (5GNR) Access Node (AN) 502 in wireless communication network 500 that generates the CDRs for the packet communications that indicate the rules and the network failures that cause the packet drops. 5GNR AN 502 comprises an example of data system 102 and processing circuitry 400, although system 102 and circuitry 400 may differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between UE 501 and NFVI 506 as described herein. In some examples, 5GNR AN 502 drops data packets based on charging actions and/or network failures and reports the packet drops along with their associated charging actions and network alarms to SMF 511.

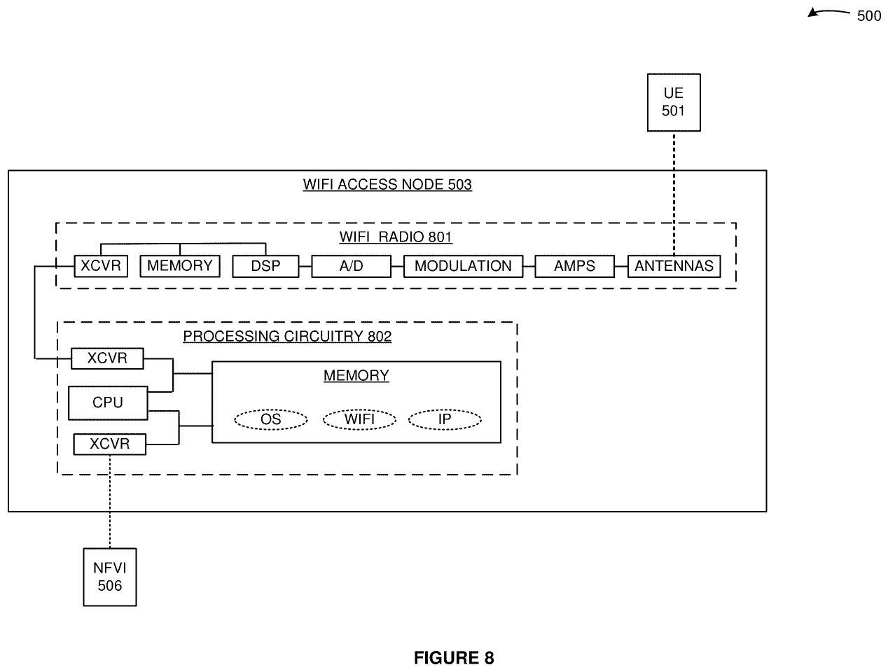

FIG. 8 illustrates exemplary Wireless Fidelity (WIFI) AN 503 in wireless communication network 500 that generates the CDRs for the packet communications that indicate the rules and the network failures that cause the packet drops. WIFI AN 503 comprises an example of data system 102 and processing circuitry 400, although system 102 and circuitry 400 may differ. WIFI AN 503 comprises WIFI radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between UE 501 and NFVI 506 as described herein. In some examples, WIFI AN 503 drops data packets based on charging actions and/or network failures and reports the packet drops along with their associated charging actions and network alarms to SMF 511.

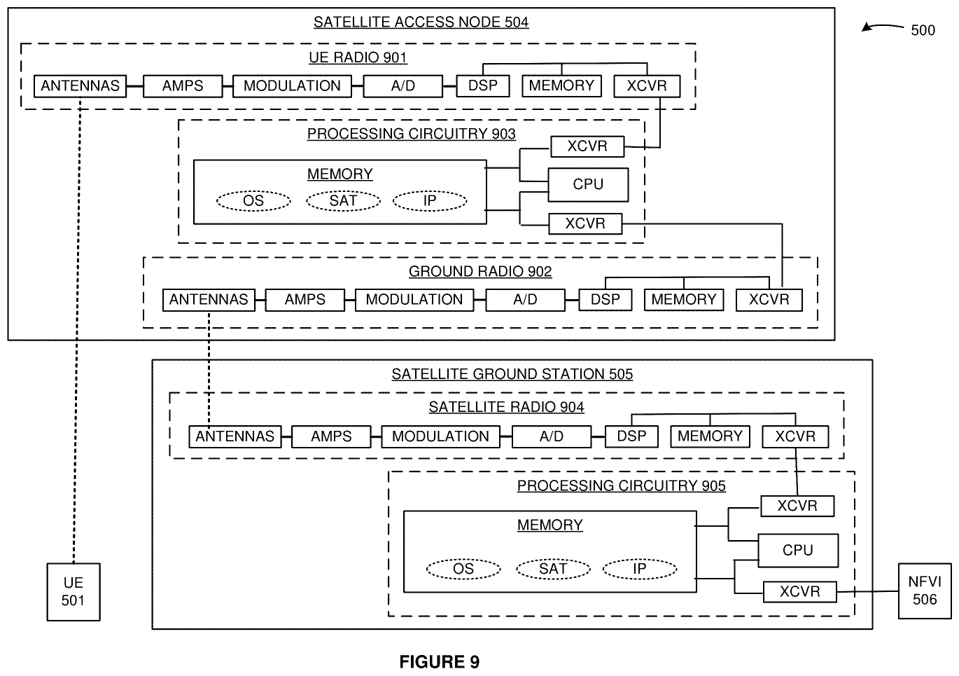

FIG. 9 illustrates exemplary Satellite (SAT) AN node 504 and SAT Ground Station (GND) 505 in wireless communication network 500 that generates the CDRs for the packet communications that indicate the rules and the network failures that cause the packet drops.

SAT AN 504 and SAT GND 505 comprises an example of data system 102 and processing circuitry 400, although system 102 and circuitry 400 may differ. SAT AN 504 comprises UE radio 901, ground radio 902 and processing circuitry 903. SAT GND 505 comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UE 501. Transceivers in UE radio 901 are coupled to transceivers in processing circuitry 903. Transceivers in processing circuitry 903 are coupled to transceivers in ground radio 902. The antennas in ground radio 902 exchange satellite signals with antennas in satellite radio 904, and the antennas in satellite radio 904 exchange the satellite signals with ground radio 902. Transceivers in satellite radio 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between UE 501 and NFVI 506 as described herein. In some examples, SAT AN 504 and/or SAT GND 505 drop data packets based on charging actions and/or network failures and reports the packet drops along with their associated charging actions and network alarms to SMF 511.

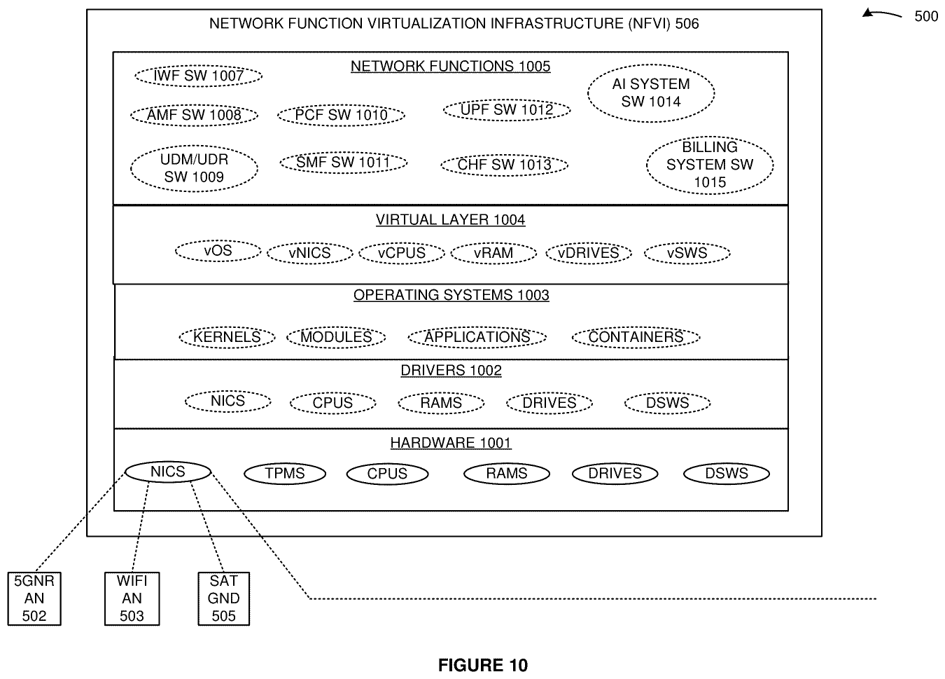

FIG. 10 illustrates exemplary Network Function Virtualization Infrastructure (NFVI) 506 in wireless communication network 500 that generates the CDRs for the packet communications that indicate the rules and the network failures that cause the packet drops.

NFVI 506 comprises an example of data system 102, control system 103, billing system 104, and processing circuitry 400, although systems 102-104, and circuitry 400 may differ. NFVI 506 comprises hardware 1001, hardware drivers 1002, operating systems 1003, virtual layer 1004, and network functions 1005. Hardware 1001 comprises Network Interface Cards (NICS), TPMs, CPUs, RAM, Flash/Disk Drives (DRIVES), and Data Switches (DSWS). Hardware drivers 1002 comprise software that is resident in the NICS, TPMs, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises IWF SW 1007, AMF SW 1008, UDM/UDR SW 1009, PCF SW 1010, SMF SW 1011, UPF SW 1012, CHF SW 1013, AI system SW 1014, and billing system SW 1015. The NICS in hardware 1001 are coupled to ANs 502-503, SAT GND 505, and external systems. Hardware 1001 executes hardware drivers 1002, operating systems 1003, virtual layer 1004, and network functions 1005 to form and operate IWF 507, AMF 508, UDM/UDR 509, PCF 510, SMF 511, UPF 512, CHF 513, AI system 514, and billing system 515 as described herein. NFVI 506 may be located at a single site or be distributed across multiple geographic areas. In some examples, IWF 507, UPF 512, or some other network element in NFVI 506 drops data packets based on charging actions and/or network failures and reports the packet drops along with their associated charging actions and network alarms to SMF 511.

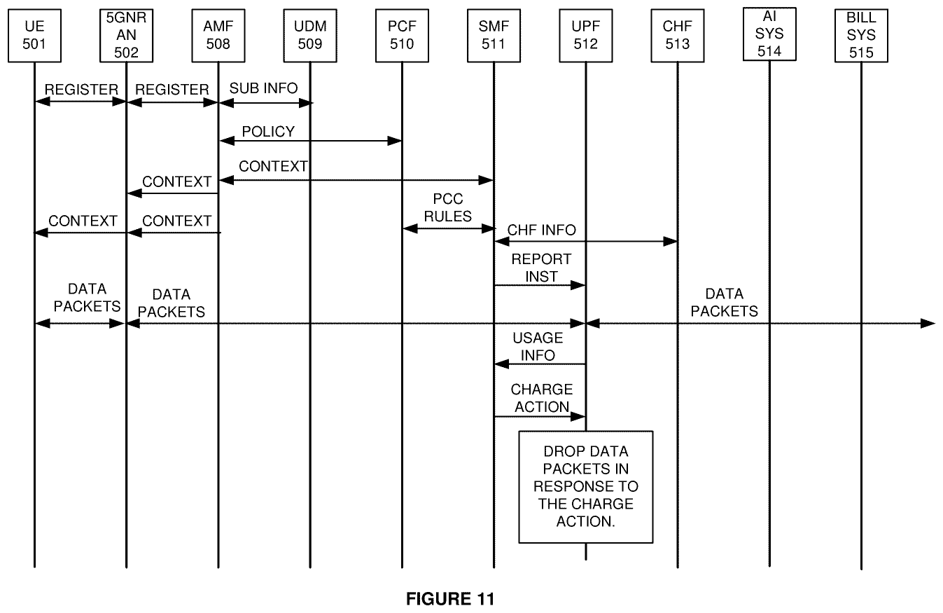

FIG. 11 illustrates an exemplary operation of wireless communication network 500 to generate the CDRs for the packet communications that indicate the PCC rules and charging actions that cause the packet drops. The operation may differ in other examples. UE 501 registers with AMF 508 over 5GNR AN 502. AMF 508 retrieves subscriber information (sub info) from UDM/UDR 509 that indicates network services for UE 501 like internet-access, data messaging, and voice calling. AMF 508 retrieves policies for UE 501 from PCF 510. AMF 508 and SMF 510 interact to develop UE context for UE 501 based on the subscriber information and the policies. The UE context indicates internet addresses, quality-of-service, and the like for the services for UE 501. AMF 508 transfers the UE context to 5GNR AN 502 and UE 501. SMF 508 transfers the UE context to UPF 512.

SMF 511 retrieves the PCC rules for UE 501 from PCF 510. SMF 511 retrieves CHF information like network status from CHF 513. SMF 508 derives usage reporting instructions based on the PCC rules and transfers the usage reporting instructions to UPF 512. The usage reporting instructions require that packet drops be characterized by their amount, time, duration, and bandwidth loss. To the extant UPF 512 is able, the usage reporting instructions further require that packet drops be associated with the pertinent PCC rule, charging action, network failure, alarm, and/or other information.

In response to the UE context, UE 501 exchanges data packets with other systems (not shown) over 5GNR AN 502 and UPF 512. UPF 512 generates usage information for UE 501 based on the usage reporting instructions. The usage information indicates the data packet flows for the network services along with their data rate, start/stop times, packet drops, and other information. For a packet drop, the usage information indicates the amount of dropped packets, the duration/time of the packet drop, and the bandwidth loss due to the packet drop. The usage information may indicate the PCC rule, charging action, network failure, and/or alarm for the packet drop. UPF 512 transfers the usage information for UE 501 to SMF 511.

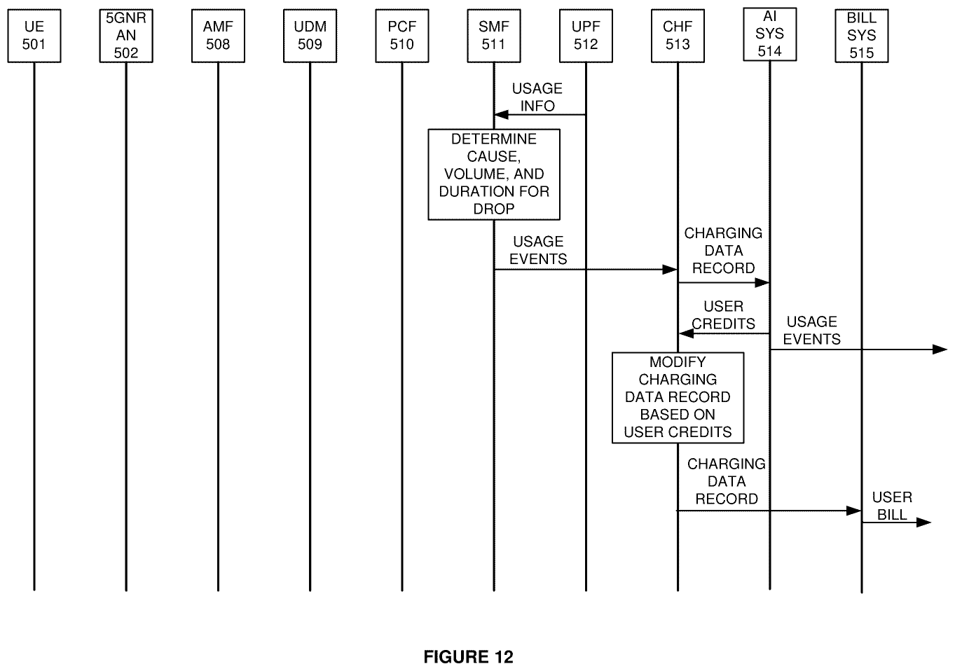

SMF 511 processes the PCC rules, usage information, and the CHF information to select a charging action for UE 501. In this example, a PCC rule for the internet-access service directs SMF 511 to implement a charging action to mitigate excessive network congestion when the data rate for UE 501 exceeds a threshold. The CHF information indicates the excessive network congestion, and the usage information for UE 501 indicates that its data rate exceeds the threshold, so SMF 511 selects a charging action to drop a portion of the downlink data packets to UE 501 for the internet access service. SMF transfers the charging action to UPF 512. UPF 512 drops some of the downlink data packets to UE 501 for the internet-access service to perform the charging action. The operation continues on FIG. 12 below.

FIG. 12 illustrates the exemplary operation of wireless communication network 500 to generate the CDRs for the packet communications that indicate the PCC rules and charging actions that cause the packet drops. The operation continues from FIG. 11 above and may differ in other examples. UPF 511 generates usage information based on the usage reporting rules. The usage information for the dropped internet-access packets indicates the packet flow, amount of dropped packets, the duration/time of the packet drop, the bandwidth loss, and the charging action.

SMF 511 generates usage events for UE 501 based on the usage information. The usage events indicate the data packets flows along with their data rate, start/stop times, packet drops, and other information. For the internet-access packet drop, the usage events indicate the amount of dropped packets, the duration/time of the packet drop, bandwidth loss, PCC rule, and charging action. SMF 511 transfers the usage events for UE 501 to CHF 513.

CHF 513 generates a CDR for UE 501 based on the usage events. The CDR indicates the data packet flows along with their data rates, start/stop times, packet drops, and other information. For the internet-access packet drop, the CDR associates the packet drop with the PCC rule and charging action. The CDR further indicates the amount of dropped packets, the duration/time of the packet drop, and bandwidth loss. CHF 613 transfers the CDR to AI system 514. AI system 514 adds user credits to the CDR for the packet drop that was caused by network congestion. AI system 514 returns the modified CDR to CHF 513 which transfers the modified CDR to billing system 514. Billing system 515 generates a user bill for the network services that implements the user credits from AI system 514.

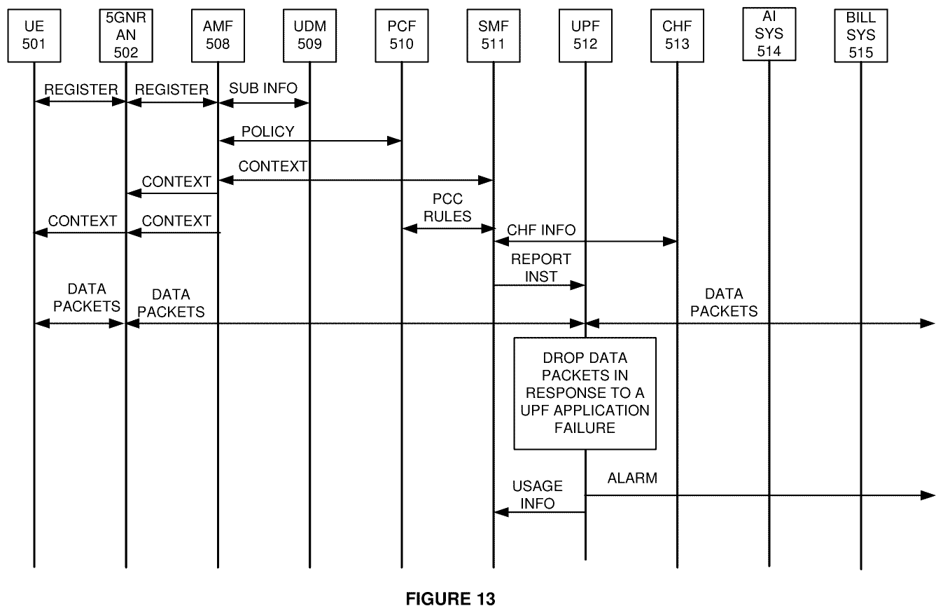

FIG. 13 illustrates the exemplary operation of wireless communication network 500 to generate the CDRs for the packet communications that indicate the network failures that cause the packet drops and the related alarms for the network failures. The operation may differ in other examples. UE 501 registers with AMF 508 over 5GNR AN 502. AMF 508 retrieves subscriber information (sub info) from UDM/UDR 509 that indicates network services for UE 501 like internet-access, data messaging, and voice calling. AMF 508 retrieves policies for UE 501 from PCF 510. AMF 508 and SMF 510 interact to develop UE context for UE 501 based on the subscriber information and the policies. The UE context indicates internet addresses, quality-of-service, and the like for the services for UE 501. AMF 508 transfers the UE context to 5GNR AN 502 and UE 501. SMF 508 transfers the UE context to UPF 512.

SMF 511 retrieves the PCC rules for UE 501 from PCF 510. SMF 511 retrieves CHF information like network status from CHF 513. SMF 508 derives usage reporting instructions based on the PCC rules and transfers the usage reporting instructions to UPF 512. The usage reporting instructions require that packet drops be characterized by their amount, time, duration, and bandwidth loss. To the extant UPF 512 is able, the usage reporting instructions further require that packet drops be associated with the pertinent PCC rule, charging action, network failure, alarm, and/or other information.

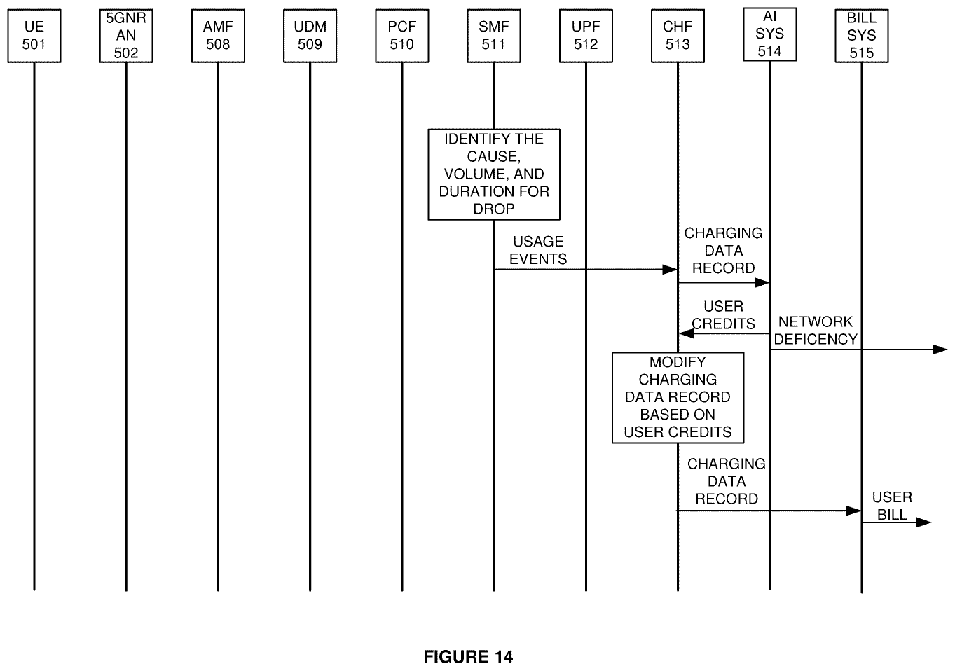

In response to the UE context, UE 501 exchanges data packets with other systems (not shown) over 5GNR AN 502 and UPF 512. Due to an application failure in UPF 512, UPF 512 drops data packets for the voice-calling service. UPF 512 generates an alarm based on the application failure. UPF 512 generates usage information for UE 501 based on the usage reporting instructions. The usage information indicates the data packet flows for the effected network services along with their data rate, start/stop times, packet drops, and other information. For the packet drop, the usage information indicates the amount of dropped packets, the duration/time of the packet drop, the bandwidth loss, the network failure, and the alarm for the application failure. UPF 512 transfers the usage information for UE 501 to SMF 511. The operation continues on FIG. 14 below.

FIG. 14 illustrates the exemplary operation of wireless communication network 500 to generate the CDRs for the packet communications that indicate the indicate the network failures that cause the packet drops and the related alarms for the network failures. The operation continues from FIG. 13 above and may differ in other examples. SMF 511 identifies the cause of the packet drop along with its volume and duration. SMF 511 generates usage events for UE 501 based on the usage information. The usage events indicate the data packet flows along with their data rate, start/stop times, packet drops, and other information. For the voice-calling packet drop, the usage events indicate the amount of dropped packets, the duration/time of the packet drop, bandwidth loss, PCC rule, UPF application failure, and alarm. SMF 511 transfers the usage events for UE 501 to CHF 513.

CHF 513 generates a CDR for UE 501 based on the usage events. The CDR indicates the data packet flows along with their data rates, start/stop times, packet drops, and other information. For the voice-calling packet drop, the CDR associates the packet drop with the UPF application failure and alarm. The CDR further indicates the amount of dropped packets, the duration/time of the packet drop, bandwidth loss, and PCC rule. CHF 613 transfers the CDR to AI system 514. AI system 514 adds user credits to the CDR for the packet drop that was caused by the network failure. AI system 514 returns the modified CDR to CHF 513 which transfers the modified CDR to billing system 514. AI system 514 indicates a network deficiency based on the UPF failure. Billing system 515 generates a user bill for the network services that implements the user credits from AI system 514.

The wireless communication system circuitry described above comprises computer hardware and software that form special-purpose data communication circuitry to generate usage information for packet communications that characterizes packet drops. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to generate the usage information for the packet communications that characterizes the data packet drops.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
receiving data packets for a user and applying a rule for the user to the data packets;
dropping the data packets in response to applying the rule; and
generating a record for the user that associates the rule with the dropped data packets.

2. The method of claim 1 wherein:
dropping the data packets comprises performing a charging action in response to applying the rule; and
generating the record for the user comprises generating the record for the user that associates the charging action with the dropped data packets.

3. The method of claim 1 further comprising:
receiving other data packets for the user;
dropping the other data packets in response to a system failure; and
generating another record for the user that associates the system failure with the other dropped data packets.

4. The method of claim 1 further comprising:
receiving other data packets for the user;
dropping the other data packets in response to a system failure that causes an alarm; and
generating another record for the user that associates the alarm with the other dropped data packets.

5. The method of claim 1 wherein generating the record comprises:
a user-plane network element generating usage information for the user based on the rule;
a Charging Trigger Function (CTF) generating event information for the user based on usage information; and
a Charging Data Function (CDF) generating a Charging Data Record (CDR) for the user based on the event information.

6. The method of claim 1 wherein generating the record comprises:
a User Plane Function (UPF) generating usage information for the user based on the rule;
a Session Management Function (SMF) generating event information for the user based on usage information; and
a Charging Function (CHF) generating a Charging Data Record (CDR) for the user based on the event information.

7. The method of claim 1 further comprising transferring the record to an Artificial Intelligence (AI) system that determines a user credit for the dropped data packets based on the record.

8. The method of claim 1 wherein the rule comprises a Policy and Charging Control (PCC) rule.

9. A method comprising:
a user-plane network element receiving data packets for a user;
a control system applying a Policy and Charging Control (PCC) rule for the user;
the user-plane network element dropping the data packets for the user in response to the control system applying the PCC rule for the user;
the user-plane network element generating usage information for the dropped data packets;
a Charging Trigger Function (CTF) generating event information for the user based on the usage information; and
a Charging Data Function (CDF) generating a Charging Data Record (CDR) for the user that associates the dropping of the user data packets with the PCC rule based on the event information.

10. The method of claim 9 further comprising:
a Policy Control Function (PCF) transferring the PCC rule for the user to the CTF; and
the CTF receiving the PCC rule for the user, generating usage reporting instructions for the user based on the PCC rule, and transferring the usage reporting instructions for the user to the user-plane network element.

11. The method of claim 9 further comprising:
the user-plane network element receiving other data packets for the user;
the user-plane network element dropping the other data packets in response to an application failure;
the user-plane network element transferring other usage information for the user to the CTF, wherein the other usage information indicates the dropping of the other data packets and the application failure;
the CTF generating other event information based on the usage information; and
the CDF generating another CDR based on the other event information that indicates the dropping of the other data packets and the application failure.

12. The method of claim 9 further comprising the CDF transferring the record to an Artificial Intelligence (AI) system that determines a user credit and a network deficiency based on the CDR.

13. A data communication system comprising:
a data system to receive data packets for a user;
a control system to apply a rule for the user to the data packets;
the data system to drop the data packets in response to the control system applying the rule; and
the control system to generate a record for the user that associates the rule with the dropped data packets.

14. The data communication system of claim 13 wherein:
the data system to perform a charging action for the user to drop the data packets in response to the control system applying the rule; and
the control system to generate the record for the user that associates the charging action with the dropped data packets.

15. The data communication system of claim 13 wherein:
the data system to receive other data packets for the user;
the data system to drop the other data packets in response to a system failure; and
the control system to generate another record for the user that associates the system failure with the other dropped data packets.

16. The data communication system of claim 13 wherein:
the data system to receive other data packets for the user;
the data system to drop the other data packets in response to a system failure that causes an alarm; and
the control system to generate another record for the user that associates the alarm with the other dropped data packets.

17. The data communication system of claim 13 wherein:
the data system is to generate usage information for the dropped data packets;
the control system comprises a Charging Trigger Function (CTF) to generate event information for the user based on the usage information; and
the control system comprises a Charging Data Function (CDF) to generate a Charging Data Record (CDR) for the user based on the event information, wherein the CDR associates the rule with the dropped data packets.

18. The data communication system of claim 13 wherein:
the data system comprises a User Plane Function (UPF) to generate usage information for the dropped data packets;
the control system comprises a Session Management Function (SMF) to generate event information for the user based on the usage information; and
the control system comprises a Charging Function (CHF) to generate a Charging Data Record (CDR) for the user based on the event information, wherein the CDR associates the rule with the dropped data packets.

19. The data communication system of claim 13 wherein the rule comprises a Policy and Charging Control (PCC) rule.

20. The data communication system of claim 13 wherein the control system is to transfer the record to an Artificial Intelligence (AI) system that identifies a technical deficiency with the data communication system in response to the record.
